(19) United States
(12) Patent Application Publication
(10) Pub. No.: US 2026/0206985 A1
(43) Pub. Date: Jul. 23, 2026

(54) CHILD ENVIRONMENT SOOTHING SYSTEM

(71) Applicant: Evenflo Company, Inc., Miamisburg, OH (US)

(72) Inventors: Matthew Eric LEWIS, Boston, MA (US); Jessica POPELKA, Charlotte, NC (US); Sharon RUGGIERI, Foxborough, MA (US); Michael Brian WILLIAMS, JR., Cincinnati, OH (US)

(21) Appl. No.: 19/027,081

(22) Filed: Jan. 17, 2025

(51) Int. Cl. A47D 15/00; A47D 13/02

(52) U.S. Cl. CPC A47D 15/00; A47D 13/02

(57) ABSTRACT

Embodiments of the present disclosure are generally directed to a child soothing system. The child soothing system can comprise various components integrated into a handle of a child carrier to monitor environmental conditions such as ambient light, sound, temperature, and motion. The system may include LEDs and a speaker integrated into the handle, with one or more processors configured to adjust the brightness of the LEDs and volume of the speaker in real-time based on detected environmental data. The system can generate alerts using the LEDs, speaker, or both, and communicate notifications to an external device, such as a mobile phone, when necessary.

### BACKGROUND

Numerous countries around the globe have car seat requirements for the safe transport of children. Typically, car seats are required to be installed in the back seat of a motor vehicle. This often leaves an infant or child alone, as the adult is usually unable to assist with the child's needs while driving the vehicle. For instance, a child may grow tired and agitated in the seat and need assistance soothing. A child may also grow restless and bored and desire entertainment. An adult driver cannot offer these things to a child without compromising the safety of everyone in the vehicle.

### DETAILED DESCRIPTION OF THE DRAWINGS

The present disclosure is described in detail below with reference to the attached figures, wherein:

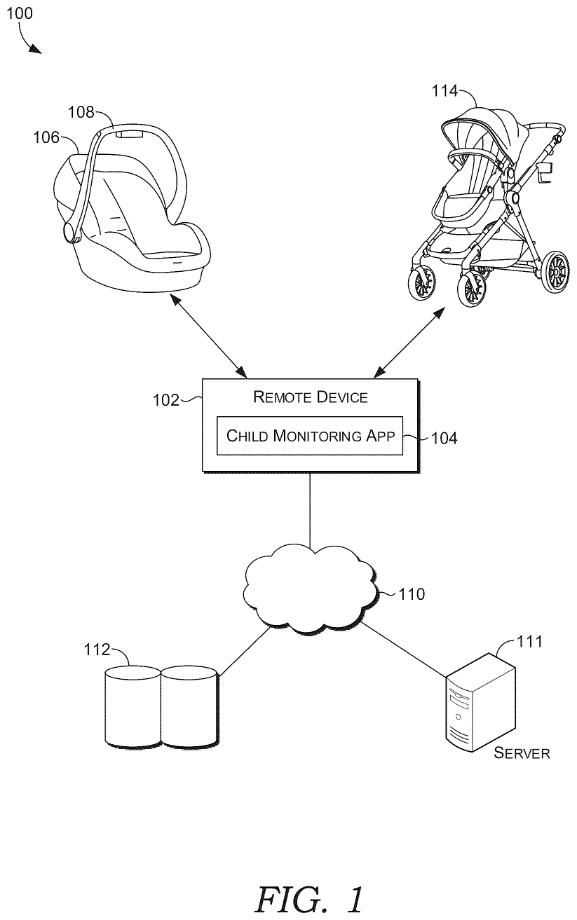

FIG. 1 is a schematic depiction illustrating an example system in which some aspects of the present disclosure may be employed;

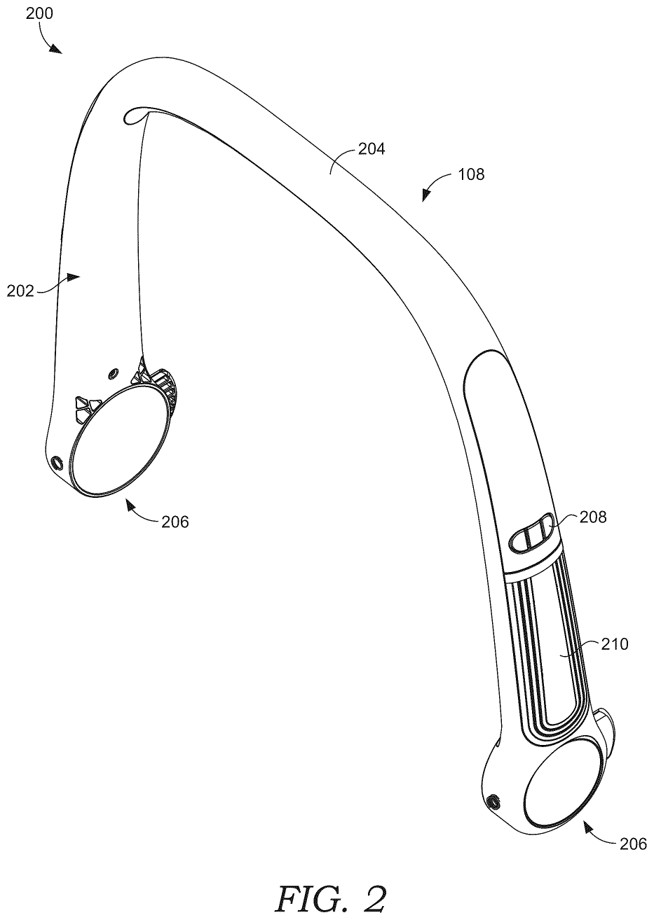

FIG. 2 is an perspective view of a handle shown in isolation in accordance with aspects of the present disclosure;

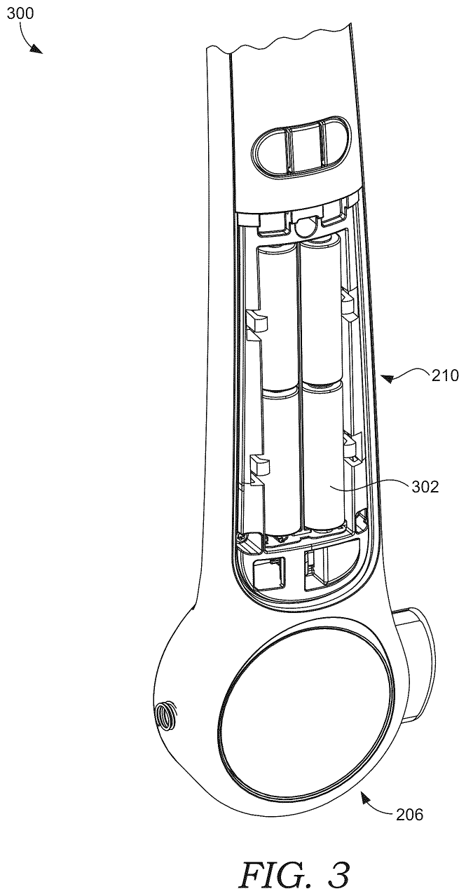

FIG. 3 is a perspective view of the handle with the power-source cover in the open position in accordance with aspects of the present disclosure;

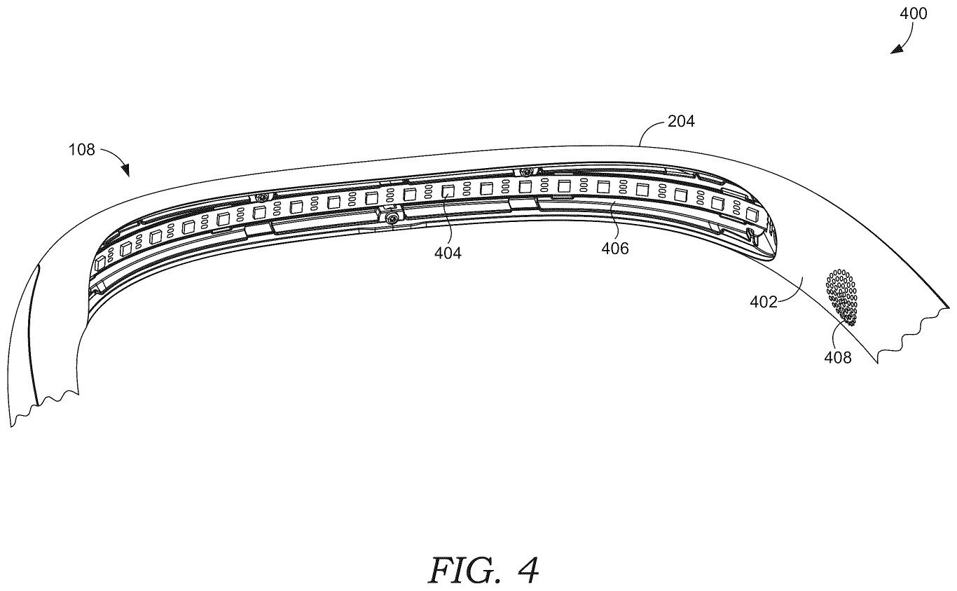

FIG. 4 is a perspective view of the handle in isolation in accordance with aspects of the present disclosure;

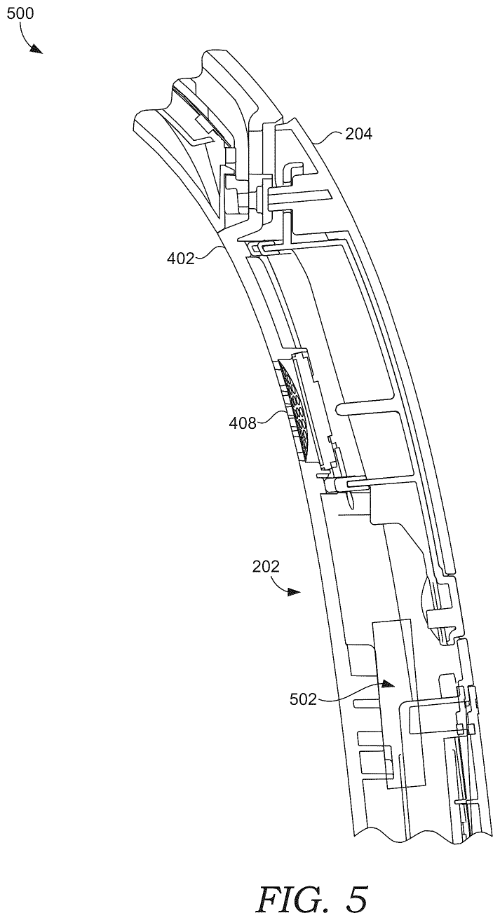

FIG. 5 is a cross-sectional view of the handle in accordance with aspects of the present disclosure;

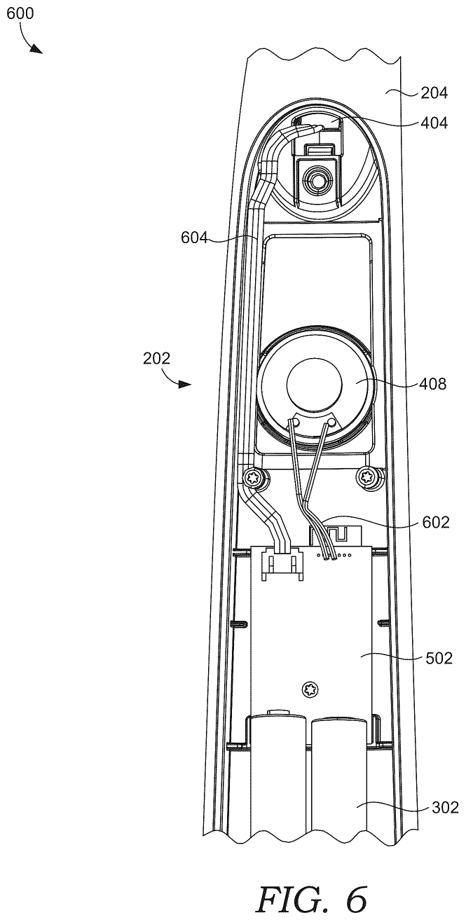

FIG. 6 is a cross-sectional view of the handle in accordance with aspects of the present disclosure;

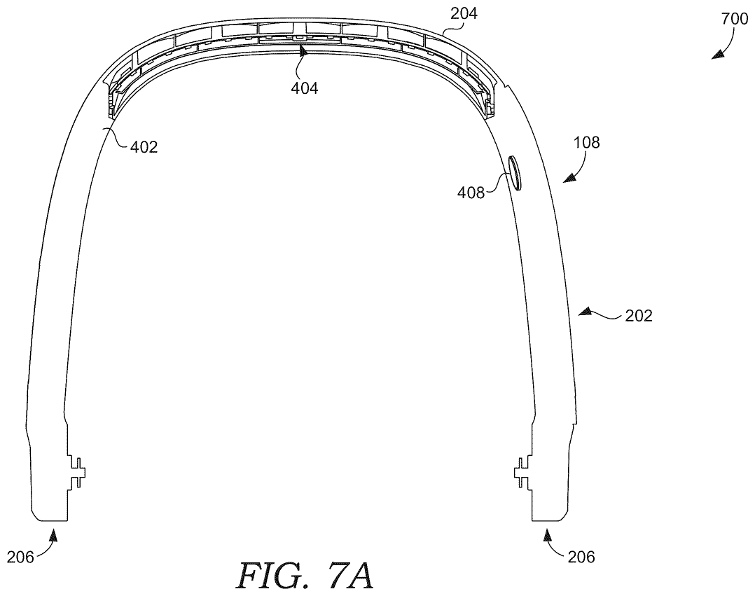

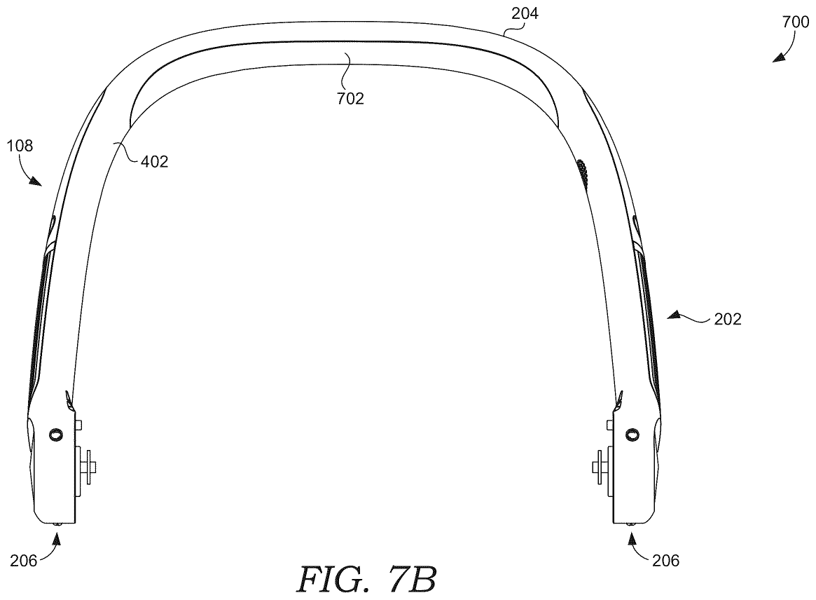

FIG. 7A is a perspective view of the handle in accordance with aspects of the present disclosure;

FIG. 7B is a perspective view of the handle in accordance with aspects of the present disclosure; and

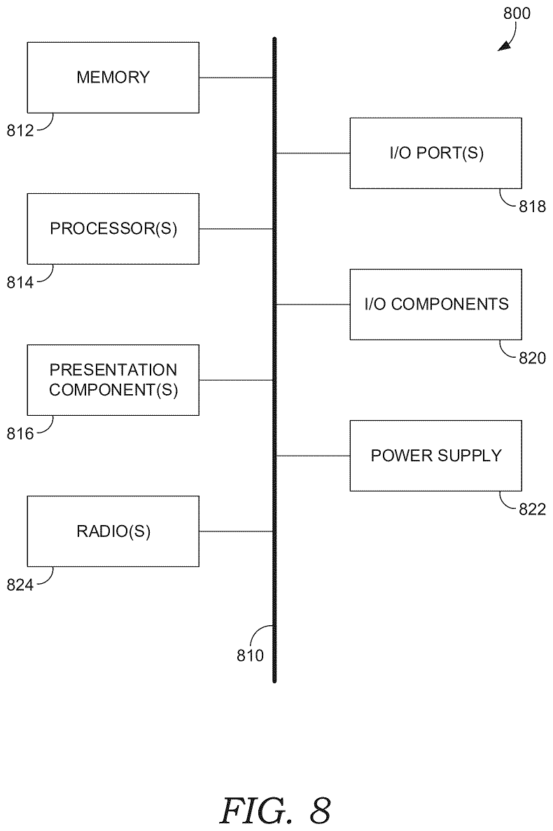

FIG. 8 is an example operating environment in accordance with aspects of the present disclosure.

### DETAILED DESCRIPTION

Embodiments herein provides a soothing system for child transport items (e.g., car seats, strollers, and the like). For simplicity, the term “car seat” and “child carrier” will be used throughout to describe examples and embodiments herein, but use of these terms is not meant to exclude additional items that may utilize features of the present embodiments. As described in greater detail below, the soothing system may be utilized for many features including soothing of a child in a car seat via lights and/or sounds. The soothing system herein may be referred to as an intelligent system, which is used herein to describe a computing system that may gather, analyze, apply, and communicate data to the user.

In contrast to other systems, embodiments of the present disclosure are generally directed to a soothing system that allows real-time adjustments based on real-time data and automated alerts using the real-time data. For instance, conventional methods for calming a crying or distressed child in a car seat, such as playing soothing music, using hanging toys, or installing backseat mirrors, have limitations that often make them inadequate or even unsafe for providing effective comfort to the child. Audio systems, for instance, may be useful for playing calming music or white noise, but they do not always hold the child's attention, especially if the child is already agitated. Hanging toys or mobiles may serve as temporary distractions, but these methods require physical installation and frequent adjustment, and they lose effectiveness over time as the novelty wears off. Additionally, many after-market car seat accessories, such as hanging toys and mirrors, are not crash-tested with the car seat and may compromise its safety. In the event of a crash, these accessories could become dangerous projectiles, further endangering the child. Mirrors provide visual stimulation and allow the child to see their reflection, but they do not address the child's deeper need for comfort or emotional connection. Furthermore, mirrors are intended primarily for parental monitoring rather than directly calming the child.

One of the most significant drawbacks of these methods is the lack of interactivity and personalized response. Babies and children often require a combination of auditory, visual, and tactile comfort to calm down, and these conventional solutions offer only one type of stimulus. Additionally, many of these methods necessitate parental intervention, which may lead to unsafe driving practices, such as reaching into the back seat while driving or making frequent stops to attend to the child. This not only compromises the driver's focus but also creates a safety risk for everyone in the vehicle. Even tools like baby monitors with two-way communication are limited because they still require the parent to be actively involved, which may be distracting and insufficient for calming a distressed child. Overall, the passive and generic nature of these conventional methods, combined with the need for constant adult interaction, demonstrates the need for more advanced, integrated solutions that may soothe a child effectively and safely without compromising the driver's attention.

According to some examples herein, the present child soothing system includes a device, for example, as integrated into or as controlling components that are integrated into a handle for a child carrier, with sensors and processors that may intelligently activate or deactivate features, such as light emitting diodes (LEDs) and sound output, based on environmental conditions and user preferences. The system further provides an alert feature by adjusting the LEDs, speaker, or both when unsafe environmental conditions (e.g., extreme temperature or high noise levels) are detected, ensuring a safe and comfortable environment for the child. This provides a desirable environment for a child and a safely monitored environment that is easily accessible and viewable to a user. In some embodiments, the system may support multiple caregivers or multiple children in a vehicle. For example, the system may synchronize music or soothing scenes across multiple child carriers, enabling multiple caregivers to monitor and manage the favorite settings of one or more children seamlessly from their respective devices. Some examples of the present disclosure may include a soothing system that aids in soothing the child without interfering with an adult's ability to operate the vehicle. Additionally, a soothing system that assists the adult with various safety and comfort tasks is described herein.

FIG. 1 depicts an example of a soothing system 100 as integrated into or as controlling components that are integrated into a handle for a child carrier. It should be understood that this and other arrangements described herein are set forth only as examples. Other arrangements and elements may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in a memory.

The soothing system 100 of FIG. 1 includes a remote device 102 that runs a child monitoring computerized application 104, a car seat 106 (hereinafter “car seat” or “child carrier” are used interchangeably herein) having a handle 108, a network 110, a server 111, and a database 112. Put simply, the remote device 102 (having the child monitoring application 104 installed thereon) may be in communication with the car seat 106 and any components thereof, including the handle 108 and/or one or more processing devices associated with the car seat 106 to enable/disable performance of certain features described herein. The data exchanged between the car seat 106 and the remote device 102 may be stored in a database, such as database 112 and/or server 111, in local memory of the remote device 102, in local memory integrated within the car seat 106 and/or its handle 108, or any combination thereof. Specific data exchanged and features controlled on the car seat 106 are discussed herein below. While the car seat 106 is utilized herein as the primary example, soothing system 100 may be utilized in other products such as a stroller 114, a bouncer/rocker (not shown), a baby swing (not shown), and the like.

The remote device 102 may include any computing device, such the computing device 800 of FIG. 8. The remote device 102 may be in the form of a smart phone, a smart watch, a tablet, a laptop, a gaming device, or the like, though a portable device is preferred. The remote device 102 may include one or more wireless communication modules for short-range communication (for example, Bluetooth), long-range communication (for example, Wi-Fi), and telecommunications service communications (for example, LTE, 3G, 4G, 5G), among other things. In some embodiments, the remote device 102 may also include integrations with in-vehicle systems, which allow for seamless connectivity and functionality within a vehicle environment. The telecommunications service communications facilitate Wide Area Network (for example, Internet) connectivity from the remote device 102. In some embodiments, the remote device 102 includes a wireless hotspot that activates a Wi-Fi access point within the remote device 102, so that other computing devices within a transmissible range of a Wi-Fi access point may connect thereto and utilize a network 110 (for example, Internet) connectivity of the remote device 102.

Similarly, the car seat 106 may include a computing device, such as the computing device 800 of FIG. 8. The car seat 106 may include one or more wireless communication modules, such as a Bluetooth module, a Wi-Fi module, or any other short or long range wireless communication module that facilitates communication between the car seat 106 (and components thereof, such as the handle 108) and one or more computing devices, such as remote device 102, a vehicle display system (e.g., vehicle infotainment system), or a computing device 800 described with reference to FIG. 8. In some examples, car seat 106 may include (e.g., on the handle 108), one or more output components (e.g., I/O component 820 associated with the computing device 800). For example, the car seat 106 may include speakers, lights (e.g., LEDs), display screen or monitor, haptic vibrational component, etc.

Turning now to FIG. 2, a perspective view 200 of the handle 108 is shown in isolation, in accordance with aspects of the present disclosure. The handle 108 comprises a body 202 having a curved or arcuate shape, a top side 204 and a bottom side 402 (see FIG. 4) of the body 202 that span a midline of the body 202 and that are configured for being grasped by a hand, and two terminal ends 206 positioned at opposite distal ends of the body 202 relative to each other, and which flank the top side 204. The body 202 forms the main structure that serves as the handle 108, providing a robust and ergonomic grip for the caregiver when lifting or carrying the car seat 106. The top side 204 and bottom side 402 of the body 202 are contoured surfaces for additional comfort when grasped in the hand. The top side 204 is generally oriented as an exterior-facing surface while the bottom side 402 is generally oriented as an interior-facing surface. The two terminal ends 206 are configured to attach securely to the first and second sidewalls of the car seat 106, for example, to securely attach one terminal end to an exterior of a right sidewall of the car seat 106 while the other terminal ends securely attaches to an exterior of a left sidewall of the car seat. Both of the terminal ends 206 may extend for a length that is parallel or substantially parallel to the exterior surface of the sidewalls of the car seat 106, such that the handle 108 eventually curves to form the top side 204 and the bottom side 402, which are orthogonally or substantially orthogonal to the extension or length of the terminal ends 206. The terminal ends 206 engage with corresponding attachment points on the car seat 106, ensuring stability and allowing the handle 108 to pivot between different positions, such as a carrying position and a stowed position. As attached to the car seat 106, the terminal ends 206 connect to or transition into the top side 204 and the bottom side 402 of the handle 108 to form the arcuate shape of the handle 108 that spans over and above a seatback and seat pan of the car seat 106.

The handle 108 comprises one or more function buttons 208. The function button 208 may be physically depressed or touch-sensitive for activation, de-activation, or toggling between various functionalities, for example, as further discussed hereinafter. In some embodiments, the touch-sensitive activation may include additional input mechanisms, such as a scroll wheel, to provide enhanced control over specific functionalities. The function button 208 may be any shape, color, size, or texture, may be raised or recessed into the handle 108, or any combination thereof. The function button 208 may be positioned on an exterior-facing surface of the handle 108 to allow easy access, enabling specific operations such as activating a light and/or sound feature while the exterior-facing surface placement is such that a child occupying the car seat 106 cannot engage the function button 208. The function button 208 may be positioned on an exterior-facing surface of the terminal ends 206 in some examples, such that the function button 208 may not be accidently engaged while the user is carrying the car seat 106 via the handle 108.

The handle includes a power-source cover 210. The power-source cover 210 may be located on the exterior surface of the body 202 of the handle 108, and may be removed for providing access to an internal compartment that houses the power source(s) for electronic features integrated into the handle 108, for the similar reasons of preventing child tampering, enabling parental ease of access, and preventing accidental removal of the power-source cover 210 while the user is carrying the car seat 106 via the handle 108. While FIG. 2 illustrates the power-source cover 210 in a closed position, FIG. 3 illustrates the power-source cover 210 in an open position, revealing batteries 302 housed inside the handle 108. The batteries 302 provide power to various components integrated into the handle 108, such as the LEDs 404 the speaker 408, and wireless communications components (not shown). It should be noted that while FIG. 3 illustrates a battery compartment with removable batteries, the present invention is not limited to this specific power source. In some embodiments, for example, the handle 108 may be powered directly from a car battery by connecting to car outlet ports. In other embodiments, the handle 108 could be equipped with a rechargeable power system, allowing the handle 108 to be recharged via a charging port or a wireless charging pad. The power sources may be controlled by the soothing system, as further discussed herein, to power on, power off, and/or place the components of the handle 108 into a powering saving mode.

Turning to FIG. 4, a perspective view (400) of the handle 108 is shown with an LED cover of the bottom surface 402 being removed, highlighting integrated components. As visible in FIG. 4, the bottom side 402 of the handle 108 includes an LED light strip (LEDs) 404, which is housed in an LED strip carrier 406, and which may be controlled by the soothing system to provide illumination that may be activated as needed, for instance, to visibly check on the child or provide ambient lighting. It should be noted that while FIG. 4 shows LEDs 404 as a strip of LEDs, the light source is not limited to this specific type of lighting; other forms of illumination, such as incandescent bulbs, OLEDs, or similar lighting elements, could be used. In addition to housing the LED strip, the LED strip carrier 406 may also function to diffuse the light emitted by the LEDs 404, providing a softer and more uniform illumination for the comfort of the child. The LEDs 404 are completely or partially contained within the handle 108 itself, to protect the LEDs 404 from environmental (e.g., rain) and/or accidental (e.g., liquid spills) damage. Additionally, integrated into the handle 108 is a speaker 408, which may be controlled to emit sounds or calming music to soothe the child by the soothing system. The handle 108 may include one or more apertures that pass through the housing of the handle 108, as visible in FIG. 4, and which are positioned to align with the location of the speaker 408. Thus, a diaphragm (visible in FIG. 5) of the speaker 408 that is within the body 202 of the handle 108 is oriented or directed toward the one or more apertures, to allow the output of the speaker 408 to reach a child in the car seat 106 and to avoid muffling the sound. The LEDs 404, the LED strip carrier 406, and the speaker 408 are positioned along the bottom side 402 of the handle 108 in various embodiments, ensuring they are effectively concealed when not in use, while still being functional when activated as within the field of view and hearing range of a child occupying the car seat 106, for example, when the handle 108 is positioned for carrying. This arrangement allows for enhanced usability and convenience, providing both visual and auditory comfort features directly from the handle 108.

Turning to FIG. 5, a cross-sectional view 500 of the handle 108 is shown, highlighting the internal components that enable integrated functionalities. As shown in FIG. 4, the handle 108 comprises the speaker 408, integrated into the body 202 of the handle 108 to produce audio output, such as calming music, white noise, or alerts to environmental changes (e.g., temperature notifications). The handle 108 also comprises an electronics board 502, which is a central hub for managing the various electronic functions and facilitating communication between the handle 108 and external devices, such as a mobile phone application (e.g., child monitoring application 104). The electronics board 502 may also include a local memory to store firmware, user-defined settings, or pre-configured profiles for light and sound behavior locally.

In some examples, the electronics board 502 includes one or more processors and I/O components 820 configured to control various functions of the handle 108 and communicate with external devices such as computing device 800. In various aspects, the electronics board 502 is configured to interface with a plurality of sensors integrated into the handle, which may include one or more of light sensors for detecting ambient light, sound sensors for monitoring background (i.e., ambient) noise levels, vibration sensors for detecting vehicle movement, temperature sensors for detecting environmental temperature, and motion sensors (e.g., accelerometers, gyroscopes) to detect movement and position of the child carrier 106. In aspects, the vibration sensors allow the system to wake the computing device 800 when the child is being placed into the car seat and also enable features such as continuing soothing scenes through the end of the ride by detecting when vehicle vibrations from driving have stopped. In some aspects, the electronics board 502 may further include an infrared (IR) sensor or a microphone for capturing sound data, expanding the handle's 108 ability to monitor the environment around the child.

In some examples, the electronics board 502 may include multiple sensors (e.g., multiple of the same type of sensor or different types of sensors), which may be integrated in the same general location (e.g., in the handle 108) or in different locations in the environment and/or on the car seat 106. The sensor(s) may be attached to or integrated within any other portion of the car seat 106 or another location appropriate to monitor a child (e.g., a handle of a stroller, rocker, bouncer, infant swing, etc.). In various aspects, the plurality of sensors are strategically integrated along or within the handle 108 to gather real-time environmental data. For example, ambient light detection by the sensors may allow the electronics board 502 to adjust the brightness level and/or the color temperature of the LEDs 404 in the handle 108, and may also provide the capability to turn the brightness on or off. Similarly, sound sensors may monitor background noise and dynamically adjust the speaker 408 volume to maintain a soothing sound level, and may also comprise the capability to turn the sound on or off. The temperature sensors may trigger the LEDs 404 to change to predetermined colors (e.g., red for high temperatures, blue for low temperatures) to provide visual and/or audio alerts about unsafe environmental conditions. For example, the temperature sensors may be configured to activate the LEDs 404 to emit a first predetermined color when the ambient temperature exceeds an upper threshold and to emit a second predetermined color when the ambient temperature is below a lower threshold.

In embodiments, the electronics board 502 may be configured to enable or disable features based on the movement of the child carrier 106 as detected by the motion sensors. For example, the accelerometer may detect when the carrier 106 is stationary for a prolonged period, prompting the processor to disable the LEDs 404 and the speaker 408 to conserve power. In aspects, the system may enter a sleep state to further conserve power when the carrier 106 has been stationary for an extended period. To use the mobile app in such instances, the system must be woken up from its sleep state to establish a connection with the user's mobile device. Alternatively, when motion is detected (e.g., rocking or carrying), the system 100 may activate specific soothing settings. In some examples, the user interface of the handle 108 may comprise one or more function buttons 208 positioned on the exterior-facing surface of the handle 108, for ergonomic access, allowing the caregiver to activate or bookmark specific light and sound settings. These settings may be stored in a memory on the network 110 or locally on the child carrier 106, and may be recalled by pressing the function button 208, providing easy access to user-preferred configurations.

The handle 108 may further integrate with external systems or devices via wireless communication, allowing real-time alerts and notifications to be sent to the child monitoring application 104 on a connected smartphone or tablet, such as the remote device 102. Such notifications could include warnings about unsafe temperatures. The electronics board 502 may also support software updates and remote customization, allowing the user to configure how the LEDs 404 and the speaker 408 respond to changes in environmental conditions or movement of the child carrier 106.

In some embodiments, the LEDs 404 may display a variety of different patterns or colors based on bookmarked soothing actions, which may be stored as part of the user-defined settings in the child monitoring application 104. These actions may include predefined combinations of sound and light patterns that may be recalled via the function button 208 or in the child monitoring application 104. The system 100 may also incorporate manual overrides through the user interface or child monitoring application 104, allowing the caregiver to control the brightness, color, sound volume, or other features of the handle 108 directly. In aspects, the handle 108 may comprise a touch-sensitive panel for manual adjustment of the color, the brightness level and/or the volume level, as discussed above.

In addition to monitoring environmental conditions, the system 100 may detect and assess changes in the child carrier's 106 environment that may affect the child's well-being. The electronics board 502 integrated within the handle 108 comprises sensors that may detect ambient light, sound, temperature, and movement, and may adjust output accordingly. For example, light sensors within the handle 108 may adjust the brightness level of the LEDs 404 based on the ambient light detected, ensuring optimal lighting without startling the child. Similarly, sound sensors may monitor background noise levels and adjust the speaker 408 volume to maintain a soothing environment.

Turning now to FIG. 6, a cross-sectional view 600 of the top side 204 of the handle 108 is shown, detailing the wiring connections for internal components. The handle 108 comprises speaker wires 602 and LED wires 604. As shown in FIG. 6, the speaker wires 602 run from the electronics board 502 to the speaker 408, providing the necessary electrical connection to produce sound. Similarly, the LED wires 604 connect the LEDs 404 to the power source (e.g., batteries 302) and electronics board 502, allowing for controlled illumination. These wiring connections are securely housed within the handle's 108 body 202 to ensure durability and safety, while maintaining a streamlined design that prevents any interference with the user's grip or operation of the handle 108.

Turning now to FIGS. 7A and 7B, two perspective views 700 of the handle 108 are shown. In FIG. 7A, the handle 108 is shown with the LED cover of the bottom surface 402 being removed, to illustrate the placement of the LEDs 404on the bottom side 402 of handle 108, similar to FIG. 4. In FIG. 7B, the handle 108 is shown with a cover 702. In aspects, the cover 702 serves to protect the LEDs 404 from dust, damage, and contact, while still allowing the LEDs 404 to function effectively. The cover 702 may be of any suitable material. In various embodiments, the cover 702 may be made of a translucent material and could be designed to diffuse the light, filter it, or simply protect the LEDs 404 while allowing some level of visibility for the child.

Machine learning models may be employed to improve the accuracy of the system 100's responses. For example, classification algorithms trained on environmental data (e.g., temperature, light, and sound patterns) may anticipate the child's needs by adjusting light or sound output in real time. The system 100 may also use motion pattern recognition models to differentiate between normal rocking motions and sudden impacts (e.g., during a car accident or fall). These models may run locally on the electronics board 502, on a connected mobile device, or through a cloud service to optimize performance and reduce false alerts.

In aspects, detecting that a child is present in the child carrier 106 may control the activation of features using machine learning-based behavior detection models. For example, sound patterns detected by a microphone may be analyzed to identify crying sounds specific to the child, differentiating them from other noises using machine learning algorithms. This ensures that unnecessary alerts are minimized. If the system 100 determines that the child is not present, based on data from the accelerometer or light sensors, non-essential features—such as cry detection—are deactivated. This minimizes power consumption and ensures the system 100 remains efficient, only responding when needed.

In embodiments, environmental factors such as LED lighting, sound output, vibrations, or temperature alerts may be intelligently managed using both sensor inputs and machine learning models. The system 100 may switch between modes using predictive algorithms that assess sensor data to identify patterns indicating specific child needs. For example:
Entertainment Mode: Fun music activated and LEDs synced to music.
Soothing Mode: Soothing music activated and LEDs dimmed.

These modes and responses may evolve over time as machine learning models adapt to the child's habits and environmental changes. The system 100 may also learn from user behavior and adjust mode transitions or sensor thresholds accordingly, optimizing the child's comfort and safety. The system 100 may support user-preferred configurations through machine learning-powered recommendations. For example, the system 100 may suggest optimal light patterns or sound levels based on historical data from previous interactions. Users may bookmark soothing actions, which the system 100 may activate through the one or more function buttons 208 on the handle 108. Over time, the system 100's machine learning algorithms may refine these recommendations, making it easier for caregivers to activate preferred settings quickly and efficiently.

To conserve power, the system 100 may use predictive algorithms to disable or reduce activity when the child is not present. For example, based on past behavior patterns, the system 100 may predict periods when the child is unlikely to need interaction (e.g., at night) and adjust sensor polling rates or deactivate non-essential features. If the accelerometer detects movement, indicating the handle 108 is picked up, the system 100 may reactivate appropriate features.

Especially during times with extreme weather conditions (e.g., winter or summer), the system 100 may use machine learning models to enhance anti-abandonment protocols and optimize alerts generated by the LEDs 404 and speaker 408 integrated into the handle 108. Position data from a mobile device (e.g., via Bluetooth or GPS) may be analyzed to detect when the caregiver moves away from the child carrier 106. If the system 100 detects an increased distance between the caregiver's device and the child carrier 106, and detects extreme environmental conditions that may be unsafe for the child, it may issue an alert using the LEDs 404, the speaker 408, or both. Additionally, the system 100 may detect when the vehicle is turned off and issue a reminder to the caregiver to check the rear seat before exiting the car, helping to prevent accidental abandonment. In other examples, the system 100 may issue an alert to the child monitoring application 104 on the caregiver's user device.

In some instances, the system 100 may trigger pre-configured alerts, such as flashing the LEDs 404 or emitting a specific sound through the speaker 408, based on the detected distance. In other examples, machine learning models may further analyze caregiver behavior patterns to reduce false alerts by distinguishing between a quick errand and situations where the child is left unattended. If an alert is not addressed, the system 100 may escalate the response by increasing the volume of the speaker 408 or changing the LEDs 404 to a different color pattern (e.g., red) to attract attention. Emergency protocols may also be activated, such as sending GPS coordinates and/or photos to emergency services.

The system 100 may integrate with vehicle infotainment systems (e.g., Apple CarPlay, Android Auto, native systems, etc.) to communicate alerts and adjust settings dynamically. In addition to gathering information to self-adjust settings, the system 100 may include a dedicated application for infotainment systems that allows the user to directly control the device's settings. For example, users may adjust LED 404 brightness, speaker 408 volume, or other soothing features directly through the infotainment interface. The application may also display additional information, such as real-time status updates on the system's 100 operation. For example, one or more processors may monitor the ambient environment and adjust the LED 404 brightness level in real-time based on detected light conditions. This may prevent sudden changes in lighting that could distract or disturb the child or caregiver. Similarly, the processor may dynamically adjust the speaker 408 volume in real-time based on background noise levels detected inside the vehicle. For example, if road noise increases, the system 100 may increase speaker 408 volume to ensure soothing sounds remain audible to the child.

In some configurations, one or more function buttons 208 positioned along the handle may allow for one-handed operation, enabling the user to activate pre-configured playback sequences such as soothing music or white noise. The processor may also control the gradual adjustment of the LED 404 brightness to ensure smooth transitions in lighting. For example, if ambient light decreases, the LEDs 404 may gradually dim instead of immediately switching to a lower brightness level, preventing discomfort to the child.

In alternative embodiments, machine learning models may analyze environmental data from the sensors to predict when adjustments are necessary. For example, based on motion data received from the vehicle, the system 100 may activate the LEDs 404 only during periods of low light or reduce LED usage when the child carrier is stationary, conserving power. Similarly, the system 100 may predict when a playback sequence should change by detecting shifts in the environment (e.g., the car slowing down) and trigger a new sound output to match the new context.

In examples, the position of the handle 108 may influence which features are active. Machine learning models may analyze past user interactions to predict which features are most useful in different handle positions. For instance, if the handle is in an upright position, the system 100 may activate LED lighting for visibility and play soothing music. When the handle is stored, the system 100 may deactivate non-essential features to conserve power. Over time, machine learning algorithms may refine these predictions, ensuring the system 100 responds optimally to handle movement.

Machine learning algorithms may also enhance how the system 100 responds to handle position data captured by accelerometers. For example, the system 100 may recognize common user behaviors—such as rocking the carrier 106 to soothe the child—and automatically activate appropriate settings, such as dimming the LEDs 404 or playing lullabies. Similarly, if walking motion is detected, the system 100 may maintain a low-light setting to avoid disturbing the child while providing enough visibility for the caregiver. These predictive algorithms may optimize the child's comfort by adapting the system 100 to both environmental conditions and user habits.

Having described embodiments of the present disclosure, an example operating environment in which embodiments of the present disclosure may be implemented is described below in order to provide a general context for various aspects of the present disclosure. Referring to FIG. 8 in particular, an example operating environment for implementing embodiments of the present disclosure is shown and designated generally as the computing device 800. The computing device 800 is one example of a suitable computing environment and is not intended to suggest any limitation as to the scope of use or functionality of the present disclosure. Neither should the computing device 800 be interpreted as having any dependency or requirement relating to any one or combination of components illustrated.

Aspects of the present disclosure may be described in the general context of computer code or machine-useable instructions, including computer-executable instructions, such as program modules, being executed by a computer or other machine, such as a personal data assistant or other handheld device. Generally, program modules including routines, programs, objects, components, data structures, etc., refer to code that perform particular tasks or implement particular abstract data types. Aspects of the present disclosure may be practiced in a variety of system configurations, including hand-held devices, consumer electronics, general-purpose computers, more specialty computing devices, etc. Aspects of the present disclosure may also be practiced in distributed computing environments where tasks are performed by remote-processing devices that are linked through a communications network.

With reference to FIG. 8, the computing device 800 includes a bus 810 that directly or indirectly couples the following devices: a memory 812, one or more processor(s) 814, one or more presentation component(s) 816, input/output (I/O) port(s) 818, I/O components 820, an illustrative power supply 822, and radio(s) 824. The bus 810 represents what may be one or more busses (such as an address bus, a data bus, or a combination thereof). Although various blocks of FIG. 8 are shown with lines for the sake of clarity, in reality, delineating various components is not so clear, and metaphorically, the lines would more accurately be grey and fuzzy.

The computing device 800 typically includes a variety of computer-readable media. The computer-readable media may be any available media that may be accessed by the computing device 800 and includes both volatile and nonvolatile media, and removable and non-removable media that store the programs and data required for operating the handle's 108 features. The communication media typically embodies computer-readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information in the signal. By way of non-limiting example, the communication media includes wired media, such as a wired network or direct-wired connection, and wireless media, such as acoustic, RF, infrared and other wireless media. Combinations of any of the above should also be included within the scope of computer-readable media.

The memory 812 includes computer-storage media in the form of volatile and/or nonvolatile memory. The memory 812 may be removable, non-removable, or a combination thereof. Examples of memory include solid-state memory that contain data structures for controlling LED brightness, sound volume, and alert responses based on the environmental data detected by the handle's 108 sensor. Examples of hardware devices include solid-state memory, hard drives, optical-disc drives, etc. The computing device 800 includes one or more processor(s) 814 that read data from various entities such as the memory 812 or the I/O components 820 to make real-time adjustments to the LEDs 404 and speaker 408 output. For example, the processor(s) 814 may adjust the LED 404 brightness level based on ambient light detected or speaker 408 volume based on background noise, ensuring an optimal environment for the child. The presentation component(s) 816 present data indications to the user or other device. Examples of presentation component(s) 816 include a display device, a speaker, a vibrating component, etc.

The I/O port(s) 818 allow the computing device 800 to be logically coupled to other devices including the I/O components 820, some of which may be built in. The I/O components 820 may include the one or more function buttons 208 positioned on the handle 108 for easy access, allowing caregivers to manually adjust light and sound settings or activate bookmarked soothing actions. Additionally, the I/O components 820 may include sensors to monitor ambient light, sound, temperature, and motion. Outputs from these sensors provide the processor(s) 814 with real-time data, enabling automatic adjustments to the handle's 108 features to suit the current environment and the child's comfort needs. The I/O components 820 may provide a natural user interface (NUI) that processes air gestures, voice, or other physiological inputs generated by the user. In some instances, inputs may be transmitted to an appropriate network element for further processing. The NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be equipped with depth cameras, such as stereoscopic camera systems, infrared camera systems, RGB camera systems, touchscreen technology, and combinations of these, for gesture detection and recognition. Additionally, the computing device 800 may be equipped with accelerometers or gyroscopes that enable detection of motion.

As can be understood, embodiments of the present disclosure provide for, among other things, monitoring an environment and adjusting one or more features of the environment based on monitored inputs. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that the present disclosure is one well adapted to attain all the ends and objects set forth above, together with other advantages which are obvious and inherent to the system 100 and method. It will be understood that certain features and subcombinations are of utility and may be employed without reference to other features and subcombinations. This is contemplated by and is within the scope of the claims.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. Moreover, although the terms “step” and/or “block” may be used herein to connote different elements of methods employed, the terms should not be interpreted as implying any particular order among or between various steps disclosed herein unless and except when the order of individual steps is explicitly described. The examples herein are intended in all respects to be illustrative rather than restrictive. In this sense, alternative examples or implementations can become apparent to those of ordinary skill in the art to which the present subject matter pertains without departing from the scope hereof.

1. An handle for a child carrier, the handle comprising:
a plurality of sensors integrated into the handle;
a plurality of light emitting diodes (LEDs) extending along the handle;
a speaker integrated into the handle; and
one or more processors configured to modify an output of one or more of the plurality of LEDs or the speaker based on sensed data from one or more of the plurality of sensors, wherein the output is modified by:
adjusting a brightness level of the plurality of LEDs;
adjusting one or more of a brightness level,
temperature, or color of one or more of the plurality of LEDs;
adjusting a volume of the speaker; or
a combination thereof.

2. The handle of claim 1, wherein the plurality of sensors comprise a light sensor configured to detect ambient light, and wherein the one or more processors are configured to adjust the brightness level of the plurality of LEDs based on the ambient light detected.

3. The handle of claim 1, wherein the plurality of sensors comprise a sound sensor configured to detect ambient noise, and wherein the one or more processors are configured to adjust the volume of the speaker based on the ambient noise detected.

4. The handle of claim 1, wherein at least one of the plurality of sensors is configured to detect ambient temperature, and wherein the one or more processors are configured to activate the plurality of LEDs to emit a first predetermined color when the ambient temperature exceeds an upper threshold and to emit a second predetermined color when the ambient temperature is below a lower threshold.

5. The handle of claim 1, wherein the plurality of sensors comprise a motion detector, and wherein the one or more processors are configured to disable the plurality of LEDs and the speaker when the motion detector detects that the child carrier is stationary for a predetermined period of time.

6. The handle of claim 1, wherein the handle comprises a user interface, and wherein the one or more processors are configured to store a user-preferred setting for the plurality of LEDs and the speaker based on input to the user interface.

7. The handle of claim 1, wherein the plurality of sensors comprise an accelerometer to detect movement of the child carrier, and wherein the one or more processors adjust operation of the plurality of LEDs and the speaker based on the movement detection.

8. An apparatus for a child carrier, the apparatus comprising:
a handle that comprises:
a plurality of sensors integrated into the handle and configured to detect environmental conditions including light, sound, temperature, or a combination thereof;
a plurality of light emitting diodes (LEDs) extending along the handle;
a speaker integrated into the handle; and
one or more processors configured to:
modify an output of one or more of the plurality of LEDs, the speaker, or a combination thereof, based on data of the environmental conditions detected by one or more of the plurality of sensors, wherein the output is modified by adjusting a brightness level of the plurality of LEDs in near real-time, adjusting a volume of sound output by the speaker in near real-time, or a combination thereof; and
generate an alert using the plurality of LEDs or the speaker based on sensed data of the environmental conditions detected by one or more of the plurality of sensors.

9. The apparatus of claim 8, wherein the one or more processors are configured to communicate the alert in near real-time to a user device based on the data of the environmental conditions detected by the one or more of the plurality of sensors.

10. The apparatus of claim 8, the handle further comprising one or more function buttons positioned along the handle for one-handed operation of a playback sequence.

11. The apparatus of claim 8, wherein the one or more processors are configured to control the plurality of LEDs to gradually adjust the brightness level based on detected changed in ambient light to prevent rapid changes in light intensity.

12. An apparatus for a child carrier, the apparatus comprising:
a handle that comprises:
a plurality of sensors integrated into the handle, the plurality of sensors configured to monitor environmental conditions in near real-time;
a plurality of light emitting diodes (LEDs) integrated into the handle and positioned along the handle;
a speaker integrated into the handle;
a function button integrated into the handle;
a power source;
a memory; and
one or more processors configured to:
adjust one or more operational features of the plurality of LEDs and the speaker in near real-time based on the environmental conditions monitored by the plurality of sensors;
store a user-preferred setting for the plurality of LEDs and the speaker in the memory;
activate the user-preferred setting in response to input via the function button; and
cause performance of a playback sequence that controls the plurality of LEDs and the speaker according to the user-preferred setting that is activated.

13. The apparatus of claim 12, wherein the playback sequence includes a pre-programmed light and sound sequence for soothing a child.

14. The apparatus of claim 12, wherein the one or more processors are configured to execute the playback sequence, controlling the one or more operational features of the plurality of LEDs and the speaker.

15. The apparatus of claim 12, wherein the speaker is configured to output pre-recorded sounds for soothing a child, and the one or more processors are configured to automatically adjust a volume of the speaker based on ambient noise levels.

16. The apparatus of claim 12, wherein the handle comprises a transceiver configured to wirelessly receive the user-preferred setting from a user device.

17. The apparatus of claim 12, wherein the handle comprises a touch-sensitive panel for manual adjustment of a brightness level and a volume level.

18. The apparatus of claim 12, wherein the one or more processors are configured to activate a particular playback sequence based on user-input selections, triggered by the function button.

19. The apparatus of claim 12, wherein at least one of the plurality of sensors comprises a motion detector, and wherein the one or more processors is configured to deactivate the plurality of LEDs and the speaker when the child carrier is determined to be stationary based on the motion detector.

20. The apparatus of claim 12, wherein at least one of the plurality of sensors comprises an accelerometer that is configured to detect a rocking motion of the child carrier, and wherein based on the detected rocking motion, the one or more processors are configured to activate a particular playback sequence that includes a pre-programmed light and sound sequence for soothing a child.
